(19) United States
(12) Patent Application Publication
(10) Pub. No.: US 2026/0326819 A1
(43) Pub. Date: Oct. 22, 2026

(54) ENHANCED TORQUE STEER MITIGATION THROUGH INTEGRATED FRONT AND REAR STEER-BY-WIRE SYSTEMS

(71) Applicant: GM Global Technology Operations LLC, Detroit, MI (US)

(72) Inventors: Reza Hajiloo, Richmond Hill (CA); Seyedeh Asal Nahidi, North York (CA); Ibrahim A. Badiru, Novi, MI (US); SeyedAlireza Kasaiezadeh Mahabadi, Waterloo (CA); Raed Nasim Abuaita, Fenton, MI (US)

(21) Appl. No.: 19/180,305

(22) Filed: Apr. 16, 2025

(51) Int. Cl. B62D 6/00

(52) U.S. Cl. CPC B62D 6/008; B62D 6/002

(57) ABSTRACT

A system performs a method for mitigating a torque steer at a vehicle. A sensor provides data indicative of an actual yaw moment of the vehicle A processor determines a torque steer yaw moment based on a difference between the actual yaw moment on the vehicle and a desired yaw moment on the vehicle, calculates a corrective front steering angle for a front axle of the vehicle and a corrective rear steering angle for a rear axle of the vehicle, determines a corrective front rack adjustment for the front axle from the corrective front steering angle, determines a corrective rear rack adjustment for the rear axle from the corrective rear steering angle, and applies the corrective front rack adjustment to the front axle and the corrective rear rack adjustment on the rear axle to mitigate the torque steer yaw moment.

### INTRODUCTION

The subject disclosure relates to operation of vehicles and, in particular, to reducing or mitigating the effects of torque steer at the vehicle.

Torque steer is an undesirable phenomenon that causes a vehicle to pull or steer to one side during an acceleration. Torque steering occurs as a result of an unequal torque distribution to the wheels of the vehicle. Unequal torque distribution can be caused by an unequal drive shaft length, an asymmetrical suspension geometry, a differential design and uneven tire traction, among others. Current strategies for reducing torque steering include symmetrical drive shafts, optimized suspension geometry, and advanced differential systems. However, these systems are not adaptable to the occurrence of torque steering real-time. Accordingly, it is desirable to provide a system for torque steer mitigation based on real-time forces and torques on the vehicle.

### SUMMARY

In one exemplary embodiment, a method of mitigating a torque steer at a vehicle is disclosed. A torque steer yaw moment is determined based on a difference between an actual yaw moment on the vehicle and a desired yaw moment on the vehicle. A corrective front steering angle is calculated for a front axle of the vehicle and a corrective rear steering angle is calculated for a rear axle of the vehicle. A corrective front rack adjustment is determined for the front axle from the corrective front steering angle. A corrective rear rack adjustment is determined for the rear axle from the corrective rear steering angle. The corrective front rack adjustment is applied to the front axle and the corrective rear rack adjustment is applied to the rear axle to mitigate the torque steer yaw moment.

In addition to one or more of the features described herein, the method further includes determining a steering torque feedback based on the corrective front rack adjustment and the corrective rear rack adjustment and applying the steering torque feedback to a steering wheel of the vehicle.

In addition to one or more of the features described herein, the steering torque feedback is based on a difference between a total rack force and an undesired rack force due to the torque steer yaw moment and the undesired rack force is based on the corrective front steering angle and the corrective rear steering angle.

In addition to one or more of the features described herein, calculating the corrective front steering angle and the corrective rear steering angle further includes determining the corrective front steering angle and the corrective rear steering angle that optimizes an objective function.

In addition to one or more of the features described herein, the objective function includes a difference between a sum of a first yaw moment due to the corrective front steering angle and a second yaw moment due to the corrective rear steering angle and the torque steer yaw moment.

In addition to one or more of the features described herein, the method further includes adding the corrective front rack adjustment to a desired front rack displacement to obtain a total front rack adjustment and applying the total front rack adjustment to the front axle and adding the corrective rear rack adjustment to a desired rear rack displacement to obtain a total rear rack adjustment and applying the total rear rack adjustment to the rear axle.

In addition to one or more of the features described herein, the method further includes calculating the actual yaw moment on the vehicle based on at least one of a longitudinal force on a wheel and a yaw moment measured at an inertial measurement unit of the vehicle.

In another exemplary embodiment, a system for mitigating a torque steer at a vehicle is disclosed. The system includes a sensor providing data indicative of an actual yaw moment of the vehicle and a processor. The processor is configured to determine a torque steer yaw moment based on a difference between the actual yaw moment on the vehicle and a desired yaw moment on the vehicle, calculate a corrective front steering angle for a front axle of the vehicle and a corrective rear steering angle for a rear axle of the vehicle, determine a corrective front rack adjustment for the front axle from the corrective front steering angle, determine a corrective rear rack adjustment for the rear axle from the corrective rear steering angle, and apply the corrective front rack adjustment to the front axle and the corrective rear rack adjustment on the rear axle to mitigate the torque steer yaw moment.

In addition to one or more of the features described herein, the processor is further configured to determine a steering torque feedback based on the corrective front rack adjustment and the corrective rear rack adjustment and to apply the steering torque feedback to a steering wheel of the vehicle.

In addition to one or more of the features described herein, the steering torque feedback is based on a difference between a total rack force and an undesired rack force due to the torque steer yaw moment and the undesired rack force is based on the corrective front steering angle and the corrective rear steering angle.

In addition to one or more of the features described herein, the processor is further configured to calculate the corrective front steering angle and the corrective rear steering angle by determining the corrective front steering angle and the corrective rear steering angle that optimizes an objective function.

In addition to one or more of the features described herein, the objective function includes a difference between a sum of a first yaw moment due to the corrective front steering angle and a second yaw moment due to the corrective rear steering angle and the torque steer yaw moment.

In addition to one or more of the features described herein, the processor is further configured to add the corrective front rack adjustment to a desired front rack displacement to obtain a total front rack adjustment and apply the total front rack adjustment to the front axle and to add the corrective rear rack adjustment to a desired rear rack displacement to obtain a total rear rack adjustment and apply the total rear rack adjustment to the rear axle.

In addition to one or more of the features described herein, the processor is further configured to calculate the actual yaw moment on the vehicle based on at least one of a longitudinal force on a wheel and a yaw moment measured at an inertial measurement unit of the vehicle.

In yet another exemplary embodiment, a vehicle is disclosed. The vehicle includes a front road wheel actuator for controlling a front axle steering angle of the vehicle, a rear road wheel actuator for controlling a rear axle steering angle of the vehicle, and a processor. The processor is configured to determine a torque steer yaw moment based on a difference between an actual yaw moment on the vehicle and a desired yaw moment on the vehicle, calculate a corrective front steering angle for a front axle of the vehicle and a corrective rear steering angle for a rear axle of the vehicle, determine a corrective front rack adjustment for the front axle from the corrective front steering angle, determine a corrective rear rack adjustment for the rear axle from the corrective rear steering angle, activate the front road wheel actuator to apply the corrective front rack adjustment to the front axle, and activate the rear road wheel actuator to apply the corrective rear rack adjustment on the rear axle.

In addition to one or more of the features described herein, the processor is further configured to determine a steering torque feedback based on the corrective front rack adjustment and the corrective rear rack adjustment and to apply the steering torque feedback to a steering wheel of the vehicle.

In addition to one or more of the features described herein, the steering torque feedback is based on a difference between a total rack force and an undesired rack force due to the torque steer yaw moment and the undesired rack force is based on the corrective front steering angle and the corrective rear steering angle.

In addition to one or more of the features described herein, the processor is further configured to calculate the corrective front steering angle and the corrective rear steering angle by determining the corrective front steering angle and the corrective rear steering angle that optimizes an objective function.

In addition to one or more of the features described herein, the objective function includes a difference between a sum of a first yaw moment due to the corrective front steering angle and a second yaw moment due to the corrective rear steering angle and the torque steer yaw moment.

In addition to one or more of the features described herein, the processor is further configured to add the corrective front rack adjustment to a desired front rack displacement to obtain a total front rack adjustment and activate the front road wheel actuator to apply the total front rack adjustment to the front axle and to add the corrective rear rack adjustment to a desired rear rack displacement to obtain a total rear rack adjustment and activate the rear road wheel actuator to apply the total rear rack adjustment to the rear axle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle in accordance with an exemplary embodiment;

FIG. 2 shows a four-wheel diagram of the vehicle showing forces and yaw moments on the vehicle; and

FIG. 3 is a system architecture for performing a method for mitigating torque steer.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

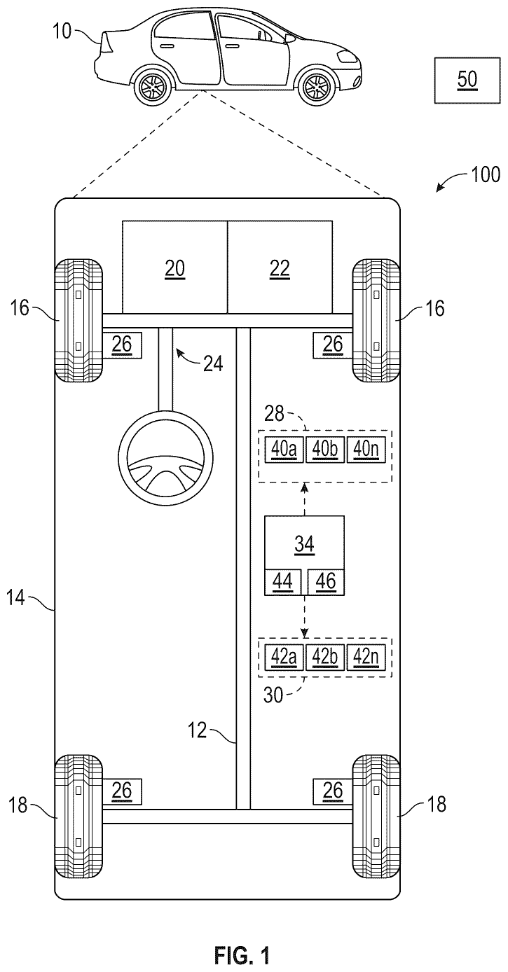

In accordance with an exemplary embodiment, FIG. 1 shows an autonomous vehicle 10 with an associated trajectory planning system depicted at 100. The vehicle us discussed herein as an autonomous vehicle 10 for illustrative purposes. However, the system and method disclosed herein are suitable for use in any vehicle, including a steer-by-wire system.

In general, the trajectory planning system 100 determines a trajectory plan for automated driving of the autonomous vehicle 10. The autonomous vehicle 10 generally includes a chassis 12, a body 14, front wheels 16, and rear wheels 18. The body 14 is arranged on the chassis 12 and substantially encloses components of the autonomous vehicle 10. The body 14 and the chassis 12 may jointly form a frame. The front wheels 16 and rear wheels 18 are each rotationally coupled to the chassis 12 near respective corners of the body 14.

In various embodiments, the trajectory planning system 100 is incorporated into the autonomous vehicle 10. The autonomous vehicle 10 is, for example, a vehicle that is automatically controlled to carry passengers from one location to another. The autonomous vehicle 10 is depicted in the illustrated embodiment as a passenger car, but it should be appreciated that any other vehicle including motorcycles, trucks, sport utility vehicles (SUVs), recreational vehicles (RVs), etc., can also be used. At various levels, an autonomous vehicle can assist the driver through a number of methods, such as warning signals to indicate upcoming risky situations, indicators to augment situational awareness of the driver by predicting movement of other agents warning of potential collisions, etc. The autonomous vehicle has different levels of intervention or control of the vehicle through coupled assistive vehicle control all the way to full control of all vehicle functions. The autonomous vehicle 10 can be any of a Level One through Level Five system. A Level 1 system includes driver assistance and performs a single autonomous task at a time, such as steering or braking. The Level 1 system can include cruise control and lane detection. A Level 2 system includes partial driving automation. Such a vehicle can control both steering and speed, but the driver must be ready to take over in an emergency. A Level 3 system is a conditional driving automation system that includes environmental detection capabilities. Such a vehicle can perform most driving tasks, but a human override is still required. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, and a controller 34. The propulsion system 20 may, in various embodiments, include an internal combustion engine, an electric machine such as a traction motor, and/or a fuel cell propulsion system. The transmission system 22 is configured to transmit power from the propulsion system 20 to the front wheels 16 and rear wheels 18 according to selectable speed ratios. According to various embodiments, the transmission system 22 may include a step-ratio automatic transmission, a continuously variable transmission, or other appropriate transmission. The brake system 26 is configured to provide braking torque to the front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The sensing devices 40a-40n obtain measurements or data related to various objects or agents 50 within the vehicle's environment. Such agents 50 can be, but are not limited to, other vehicles, pedestrians, bicycles, motorcycles, etc., as well as non-moving objects. The sensing devices 40a-40n can also obtain traffic data, such as information regarding traffic signals and signs, etc.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but not limited to, doors, a trunk, and cabin features such as ventilation, music, lighting, etc. (not numbered).

The controller 34 includes a processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. The instruction may also perform logic, calculations, methods and/or algorithms for mitigating the effects of torque steer on the vehicle using the methods disclosed herein.

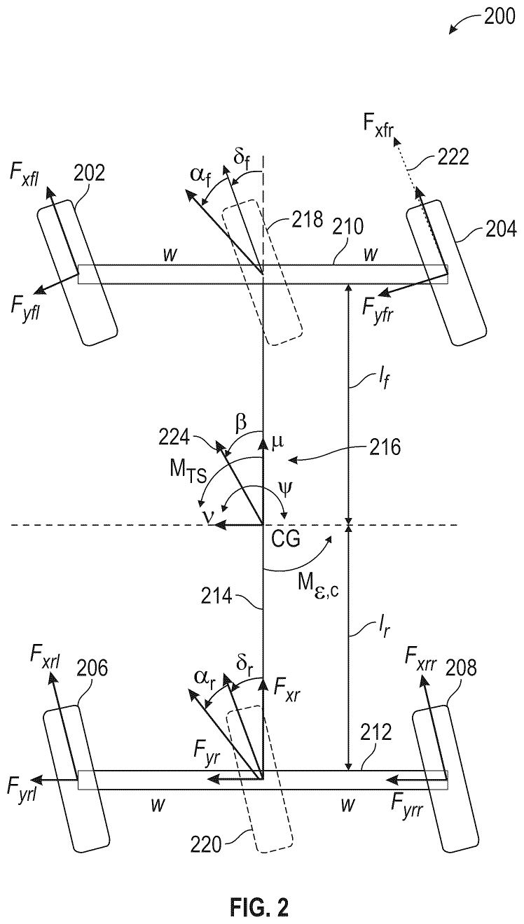

FIG. 2 shows a four-wheel diagram 200 of the vehicle showing forces and yaw moments on the vehicle. The four-wheel diagram 200 shows a front left wheel 202, a front right wheel 204, a rear left wheel 206 and a rear right wheel 208. The front left wheel 202 and the front right wheel 204 are disposed on a front axle 210 that extends laterally across the vehicle. The rear left wheel 206 and the rear right wheel 208 can be disposed on a rear axle 212 that extends laterally across the vehicle. The front axle 210 and the rear axle 212 are separated by a wheelbase along a longitudinal axis 214 of the vehicle. For the front left wheel 202, a rack length w is a distance between the front left wheel 202 and the longitudinal axis 214 at the front axle 210. Rack lengths w are similarly defined for the front right wheel 204, the rear left wheel 206 and the rear right wheel 208.

A center of gravity (CG) of the vehicle is located along the longitudinal axis 214. The CG can be, but is not necessarily, at a midpoint between the front axle 210 and the rear axle 212. The front axle 210 is separated from the CG by a front distance l_{f} and the rear axle 212 is separated from the CG by a rear distance lᵣ. A coordinate system 216 is shown at the CG, illustrating a longitudinal axis u and a lateral axis v for the vehicle.

Force components for the front left wheel 202 include a longitudinal force (F_{x,fl}) and a lateral force (F_{y,fl}). Force components for the front right wheel 204 include a longitudinal force (F_{x,fr}) and a lateral force (F_{y,fr}). Force components for the rear left wheel 206 include a longitudinal force (F_{x,rl}) and a lateral force (F_{y,rl}). Force components for the rear right wheel 208 include a longitudinal force (F_{x,rr}) and a lateral force (F_{y,rr}). For illustrative purposes, the rear axle 212 further shows a rear longitudinal force (F_{x,rr}) and a rear lateral force (F_{y,rr}) that are due to respective forces on the rear left wheel 206 and rear right wheel 208.

A virtual front wheel 218 shows a front axle steering angle δ_{f} and a front axle slip angle α_{f} at the front axle 210. Similarly, a virtual rear wheel 220 shows a rear axle steering angle δᵣ and a rear axles slip angle αᵣ at the rear axle 212.

For illustrative purposes only, a vector 222 at the front right wheel 204 represents an undesired torque steer. A torque steer yaw moment 224 (M_{TS}) is shown at the center of gravity CG. The torque steer yaw moment 224 M_{TS} is due to uneven torque distribution (e.g., due to undesired torque represented by vector 222). The Torque steer yaw moment (vector 222) is angularly separated from the longitudinal axis u by an angle β.

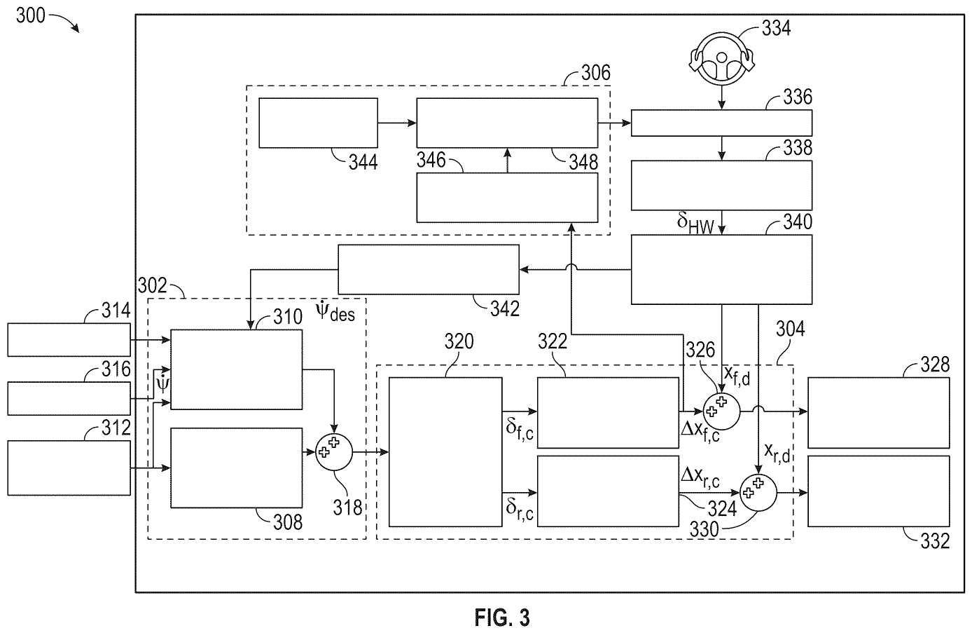

FIG. 3 is a system architecture 300 for performing a method for mitigating torque steer. The system architecture 300 includes a torque steering determination module 302 for calculating a total yaw moment for mitigation of torque steer yaw moment, a torque steer correction module 304 for receiving the total yaw moment and calculating a front axle rack travel and a rear axle rack travel based on the total yaw moment for mitigating the torque steer, and a hand wheel torque correction module 306 for determining a feedback torque at the steering wheel based on the correction.

Turning first to the torque steering determination module 302, the module includes a base function module 308 and a torque learning module 310. The base function module 308 calculates at least a transmission torque and an acceleration torque (i.e., a required torque for acceleration or deceleration) to determine a base yaw moment on the vehicle. The acceleration torque can be provided by an acceleration torque detector 312. The base yaw moment provides a feedforward control.

The torque learning module 310 calculates a corrective yaw moment (if needed) when the base function needs a correction. The torque learning module 310 determines a difference between a desired yaw rate \dot{ψ}_{des} and an actual yaw rate \dot{ψ} and outputs a torque steer yaw moment M_{TS} based on the difference. The torque learning module 310 can determine the actual yaw rate based on input from various sensors, such as the acceleration torque detector 312, a force estimator 314, and an inertial measurement unit (IMU 316). In an embodiment, the torque learning module 310 receives longitudinal forces (e.g., longitudinal wheel forces) from the force estimator 314 and calculates the actual yaw rate based on the longitudinal forces. The longitudinal forces are measured continuously in a periodic manner over a period of time.

In another embodiment, the torque learning module 310 can receive longitudinal forces from the force estimator 314 and supplement the longitudinal forces with a measured yaw rate from the IMU 316. The torque learning module 310 can receive yaw rate measurements from the IMU 316 continuously in a periodic manner over the period of time, similar to how data is received from to the force estimator 314. The force estimator 314 is thus used as a primary source for determining actual yaw rate and the IMU 316 is used as a backup to the force estimator.

A method of calculating of a difference between a torque steer yaw moment M_{TS} and a yaw moment due to a longitudinal forces of the wheels is shown in Eq. (1):

f=w/2(F_{x.fr}−F_{x.fl})−(F_{x.rr}−F_{x.rl})−M_{TS} Eq. (1)

where w is a left side rack length or right side rack length (see FIG. 2), F_{x,fr} is the longitudinal force on the front right wheel 204, F_{x,fl} is the longitudinal force on the front left wheel 202, F_{x,rr} is the longitudinal force on the rear right wheel 208, and F_{x,rl} is the longitudinal force on the rear left wheel 206.

The torque learning module 310 can provide an updated output for subsequent calculations if the yaw moment difference f appears to be continuous over a selected time frame. In various embodiments, the yaw moment difference f can be considered continuous if it meets the criteria of Eq. (2):

f>ϵ₁ for N>n₁ Eq. (2)

where N is the number of iterations over and iteration threshold n₁ and ϵ₁ is a calibratable value.

If the longitudinal force estimations are faulty or unreliable, the discrepancy between a desired yaw rate \dot{ψ}_{des} provided by the driver and the actual measured IMU yaw rate \dot{ψ} can be used to indicate an undesired vehicle yaw motion: the difference g in yaw rate is shown in Eq. (3):

g=\dot{ψ}−\dot{ψ}_{des} Eq. (3)

where g is an undesired yaw rate. The parameters of torque steering learning function of the torque learning module 310 can be updated if the yaw rate difference g is continuous over a selected time frame. In various embodiment, a yaw rate difference g can be considered continuous if it meets the criteria of Eq. (4):

g>ϵ₂ for N>n₂ Eq. (4)

where N is the number of iterations over and iteration threshold n₂ and ϵ₂ is a calibratable value.

Summation engine 318 adds the base yaw moment calculated at the base function module 308 to the torque steer yaw moment M_{TS} from the torque learning module 310 to output a corrective torque steer yaw moment. The corrective torque steer yaw moment is provided to the torque steer correction module 304. The output of the torque learning module 310 is zero if there is no error between the base function model and the actual torque steering.

Turning now to the torque steer correction module 304, this module receives the corrective torque steer yaw moment and calculates a front axle rack travel and a rear axle rack travel. The torque steer correction module 304 includes an optimization module 320, a front axle rack adjustment module 322 and a rear axle rack adjustment module 324. The corrective torque steer yaw moment from the torque steering determination module 302 is provided to the optimization module 320. The optimization module 320 calculates a corrective front steering angle δ_{f,c} and a corrective rear steering angle δ_{r,c} for the corrective torque steer yaw moment. The corrective steering angle are those additional steering angles that are produced at the vehicle to mitigate or reduce the torque steer yaw moment M_{TS}.

The lateral force F_{yf} generated in the front axle 210 due to a change in a steering command can be described as shown in Eq. (5):

F_{yf}=F_{yf,0}+C̅_{αf}Δδ_{fc} Eq. (5)

where F_{yf,0} is an initial lateral force on the front axle and Δδ_{fc} is a corrective steering angle on the front axle and indicates a change in front axle steering angle to correct for torque steer. Front axle cornering stiffness coefficient C̅_{αf} is a function of tire slip angle, slip ratio, normal force and road friction coefficient for the front axle.

The lateral force generated in the rear axle 212 due to a change in a steering command can be described as shown in Eq. (6):

F_{yr}=F_{yr,0}+C̅_{αr}Δδ_{rc} Eq. (6)

where F_{yr,0} is an initial lateral force on the rear axle and Δδ_{rc} is a corrective steering angle on the rear axle and indicates a change in rear axle steering angle to correct for torque steer. Rear axle cornering stiffness coefficient C̅_{αr} is a function of tire slip angle, slip ratio, normal force and road friction coefficient for the front axle.

The slip angle α_{f} at the front axle can be calculated using Eq. (7):

$${α}_{f} = \frac{{v}_{y} + {l}_{f} \dot{ψ}}{{v}_{x}} - ( {δ}_{f , d} - {δ}_{f , c} ) \qquad Eq . ( 7 )$$

where v_{y} is the lateral velocity of the vehicle, vₓ is the longitudinal velocity of the vehicle, l_{f} is the front length, δ_{f,d} is a steering angle at the front axle due to a driver command and δ_{f,c} is the corrective steering command at the front axle. Similarly, the slip angle αᵣ at the rear axle can be calculated using Eq. (8):

$${α}_{r} = \frac{{v}_{y} - {l}_{r} \dot{ψ}}{{v}_{x}} - ( {δ}_{r , d} - {δ}_{r , c} ) \qquad Eq . ( 8 )$$

where v_{y} is the lateral velocity of the vehicle, vₓ is the longitudinal velocity of the vehicle, lᵣ is the rear length, δ_{r,d} is a steering angle at the rear axle due to a driver command and δ_{r,c} is a corrective steering command at the rear axle.

The optimization module 320 performs an optimization procedure to determine a corrective front steering angle δ_{f,c} and a corrective rear steering angle δ_{r,c} that reduces or optimizes an objective function. The objective function aims to minimize a yaw moment resulting from torque steer. An illustrative objection function is shown in Eq. (9):

$$J = {\sum }_{k = 1}^{N} min ( {‖ y - {y}_{ref} ‖}_{{W}_{y}}^{2} + {‖ u - {u}_{ref} ‖}_{{W}_{u}}^{2} + {‖ {u}_{k} - {u}_{k - 1} ‖}_{{W}_{Δ u}}^{2} ) \qquad Eq . ( 9 )$$

The parameter y is given by Eq. (10):

y=M_{δ}_{_{f,c}}+M_{δ}_{_{r,c}} Eq. (10)

where M_{δ}_{_{f,c}} is a first yaw moment due to corrective steering angle at the front axle and M_{δ}_{_{r,c}} is a second yaw moment due to corrective steering angle at the rear axle. The parameter y_{ref} is given in Eq. (11):

y_{ref}=M_{TS} Eq. (11)

where M_{TS} is the torque steer yaw moment. Parameter u in Eq. (9) is given as a vector summation of corrective steering angles, as shown in Eq. (12):

u=δ_{f,c}+δ_{r,c} Eq. (12)

and uₖ and uₖ₋₁ are consecutive values of u.

The objective function of Eq. (9) is subject to constraints. In one constraint, the corrective front axle steering angle is bounded by a minimum value and a maximum value, as shown in Eq. (13):

δ_{f,c}_{_{lb}}=δ_{f,c}=δ_{f,c}_{_{ub}} Eq. (13)

In another constraint, the corrective rear axle steering angle is bounded by a minimum value and a maximum value, as shown in Eq. (14):

δ_{r,c}_{_{lb}}≤δ_{r,c}≤δ_{r,c}_{_{ub}} Eq. (14)

The front axles steering forces are bounded by a normal force on the front axles (i.e., front wheels), as shown in Eq. (15):

$${F}_{yf}^{2} + {F}_{xf}^{2} \leq μ {F}_{zf}^{2} \qquad Eq . ( 15 )$$

The rear axle steering forces are bounded by a normal force on the rear axles (i.e., rear wheels), as shown Eq. (16):

$${F}_{yr}^{2} + {F}_{yr}^{2} \leq μ {F}_{zr}^{2} \qquad Eq . ( 16 )$$

The front axle rack adjustment module 322 receives the corrective front steering angle δ_{f,c} and calculates a corrective front rack adjustment Δx_{f,c}. Similarly, the rear axle rack adjustment module 324 receives the corrective rear steering angle δ_{r,c} and calculates a corrective rear rack adjustment Δx_{r,c}.

A front axle summation engine 326 adds the corrective front rack adjustment Δx_{f,c} to a desired front rack displacement commanded by the driver x_{f,d} to obtain a total front rack adjustment. The total front rack adjustment is sent to a front road wheel actuator 328 which applies the total front rack adjustment at the front axle 210. Similarly, a rear axle summation engine 330 adds the corrective rear rack adjustment Δx_{r,c} to a desired rear rack displacement commanded by the driver x_{r,d} to obtain a total rear rack adjustment. The total rear rack adjustment is sent to a rear road wheel actuator 332 which applies the total rear rack adjustment at the rear axle 212.

The desired rack displacements x_{f,d} and x_{r,d} are based on a driver action at a steering wheel 334. A hand wheel actuator 336 records a steering angle 338 of the steering wheel and also provides a torque feedback to the steering wheel that represents a force at the axles. A rack displacement calculator 340 translates the steering angle 338 to a desired front rack displacement x_{f,d} and a desired rear rack displacement x_{r,d}.

The rack displacement calculator 340 can also send signals to the driver command interpreter (DCI 342). The DCI 342 can determine a desired yaw rate from these signals. The desired yaw rate can be sent to the torque learning module 310 of the torque steering determination module 302.

Turning now to the hand wheel torque correction module 306, this module determines a feedback torque at the steering wheel. The module includes a rack force estimation module 344, an undesired torque estimation module 346 and a steering torque feedback module 348. The rack force estimation module 344 determines a total force at the axles. The undesired torque estimation module 346 calculates an undesired force due to the torque steer and calculates a related undesired torque. The steering torque feedback module 348 determines a feedback torque to be applied to the steering wheel 334 by the hand wheel actuator 336.

The feedback torque is a force on the rack as a result of torque steer and is used to adjust a torque at the steering wheel to compensate for this force. The undesired rack force due to torque steer is a function of a corrective front axle displacement Δx_{f,c} and a corrective rear axle displacement Δx_{r,c}, as shown in Eq. (17):

F_{rack,TS}=f(Δx_{f,c},Δx_{r,c}) Eq. (17)

The undesired rack force is subtracted from the total rack force to determine steering force feedback, as shown in Eq. (18):

F_{rack,feedback}=F_{rack,total}−F_{rack,TS} Eq. (18)

The steering force feedback can be translated to a steering torque feedback that can be applied to the steering wheel.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of mitigating a torque steer at a vehicle, comprising:
determining a torque steer yaw moment based on a difference between an actual yaw moment on the vehicle and a desired yaw moment on the vehicle;
calculating a corrective front steering angle for a front axle of the vehicle and a corrective rear steering angle for a rear axle of the vehicle;
determining a corrective front rack adjustment for the front axle from the corrective front steering angle;
determining a corrective rear rack adjustment for the rear axle from the corrective rear steering angle; and
applying the corrective front rack adjustment to the front axle and the corrective rear rack adjustment to the rear axle to mitigate the torque steer yaw moment.

2. The method of claim 1, further comprising determining a steering torque feedback based on the corrective front rack adjustment and the corrective rear rack adjustment and applying the steering torque feedback to a steering wheel of the vehicle.

3. The method of claim 2, wherein the steering torque feedback is based on a difference between a total rack force and an undesired rack force due to the torque steer yaw moment and the undesired rack force is based on the corrective front steering angle and the corrective rear steering angle.

4. The method of claim 1, wherein calculating the corrective front steering angle and the corrective rear steering angle further comprises determining the corrective front steering angle and the corrective rear steering angle that optimizes an objective function.

5. The method of claim 4, wherein the objective function includes a difference between a sum of a first yaw moment due to the corrective front steering angle and a second yaw moment due to the corrective rear steering angle and the torque steer yaw moment.

6. The method of claim 1, further comprising adding the corrective front rack adjustment to a desired front rack displacement to obtain a total front rack adjustment and applying the total front rack adjustment to the front axle and adding the corrective rear rack adjustment to a desired rear rack displacement to obtain a total rear rack adjustment and applying the total rear rack adjustment to the rear axle.

7. The method of claim 1, further comprising calculating the actual yaw moment on the vehicle based on at least one of: (i) a longitudinal force on wheel; and (ii) a yaw moment measured at an inertial measurement unit of the vehicle.

8. A system for mitigating a torque steer at a vehicle, comprising:
a sensor providing data indicative of an actual yaw moment of the vehicle;
a processor configured to:
determine a torque steer yaw moment based on a difference between the actual yaw moment on the vehicle and a desired yaw moment on the vehicle;
calculate a corrective front steering angle for a front axle of the vehicle and a corrective rear steering angle for a rear axle of the vehicle;
determine a corrective front rack adjustment for the front axle from the corrective front steering angle;
determine a corrective rear rack adjustment for the rear axle from the corrective rear steering angle; and
apply the corrective front rack adjustment to the front axle and the corrective rear rack adjustment on the rear axle to mitigate the torque steer yaw moment.

9. The system of claim 8, wherein the processor is further configured to determine a steering torque feedback based on the corrective front rack adjustment and the corrective rear rack adjustment and to apply the steering torque feedback to a steering wheel of the vehicle.

10. The system of claim 9, wherein the steering torque feedback is based on a difference between a total rack force and an undesired rack force due to the torque steer yaw moment and the undesired rack force is based on the corrective front steering angle and the corrective rear steering angle.

11. The system of claim 8, wherein the processor is further configured to calculate the corrective front steering angle and the corrective rear steering angle by determining the corrective front steering angle and the corrective rear steering angle that optimizes an objective function.

12. The system of claim 11, wherein the objective function includes a difference between a sum of a first yaw moment due to the corrective front steering angle and a second yaw moment due to the corrective rear steering angle and the torque steer yaw moment.

13. The system of claim 8, wherein the processor is further configured to add the corrective front rack adjustment to a desired front rack displacement to obtain a total front rack adjustment and apply the total front rack adjustment to the front axle and to add the corrective rear rack adjustment to a desired rear rack displacement to obtain a total rear rack adjustment and apply the total rear rack adjustment to the rear axle.

14. The system of claim 8, wherein the processor is further configured to calculate the actual yaw moment on the vehicle based on at least one of: (i) a longitudinal force on a wheel; and (ii) a yaw moment measured at an inertial measurement unit of the vehicle.

15. A vehicle, comprising:
a front road wheel actuator for controlling a front axle steering angle of the vehicle;
a rear road wheel actuator for controlling a rear axle steering angle of the vehicle;
a processor configured to:
determine a torque steer yaw moment based on a difference between an actual yaw moment on the vehicle and a desired yaw moment on the vehicle;
calculate a corrective front steering angle for a front axle of the vehicle and a corrective rear steering angle for a rear axle of the vehicle;
determine a corrective front rack adjustment for the front axle from the corrective front steering angle;
determine a corrective rear rack adjustment for the rear axle from the corrective rear steering angle;
activate the front road wheel actuator to apply the corrective front rack adjustment to the front axle; and
activate the rear road wheel actuator to apply the corrective rear rack adjustment on the rear axle.

16. The vehicle of claim 15, wherein the processor is further configured to determine a steering torque feedback based on the corrective front rack adjustment and the corrective rear rack adjustment and to apply the steering torque feedback to a steering wheel of the vehicle.

17. The vehicle of claim 16, wherein the steering torque feedback is based on a difference between a total rack force and an undesired rack force due to the torque steer yaw moment and the undesired rack force is based on the corrective front steering angle and the corrective rear steering angle.

18. The vehicle of claim 15, wherein the processor is further configured to calculate the corrective front steering angle and the corrective rear steering angle by determining the corrective front steering angle and the corrective rear steering angle that optimizes an objective function.

19. The vehicle of claim 18, wherein the objective function includes a difference between a sum of a first yaw moment due to the corrective front steering angle and a second yaw moment due to the corrective rear steering angle and the torque steer yaw moment.

20. The vehicle of claim 15, wherein the processor is further configured to add the corrective front rack adjustment to a desired front rack displacement to obtain a total front rack adjustment and activate the front road wheel actuator to apply the total front rack adjustment to the front axle and to add the corrective rear rack adjustment to a desired rear rack displacement to obtain a total rear rack adjustment and activate the rear road wheel actuator to apply the total rear rack adjustment to the rear axle.
